(19) United States
(12) Patent Application Publication
(10) Pub. No.: US 2026/0032473 A1
(43) Pub. Date: Jan. 29, 2026

(54) STATISTICAL REPRESENTATIONS OF CELLULAR TOWERS

(71) Applicant: DISH Wireless L.L.C., Englewood, CO (US)

(72) Inventors: Joseph Patrick Fagan, JR., Littleton, CO (US); Jacob Holt Richardson, Denver, CO (US); Ariel Nunez, Littleton, CO (US); Matthew Emerson Tompkins, Parker, CO (US); Meagan Brady, Leadville, CO (US); James William Fagan, Littleton, CO (US)

(21) Appl. No.: 18/782,934

(22) Filed: Jul. 24, 2024

(51) Int. Cl. H04W 24/08

(52) U.S. Cl. CPC H04W 24/08

(57) ABSTRACT

Technologies for implementing statistical representations of tower structures in a cellular network are described. One method include receiving, by a processing device, a plurality of images of a tower structure in a cellular network; extracting a plurality of data points from the plurality of images, wherein the plurality of data points reflects a three-dimensional visual representation of the tower structure; generating, using the plurality of points, a statistical representation of the tower structure; and identifying, using the statistical representation, one or more patterns associated with the tower structure.

### BACKGROUND

Cellular networks are highly complex and expensive to build. There is a demand for representing and analyzing various structures and/or equipment used in a cellular network.

### BRIEF DESCRIPTION OF THE DRAWINGS

The present disclosure is illustrated by way of example, and not by way of limitation, in the figures of the accompanying drawings.

FIG. 1 is a block diagram of a system implementing statistical representation of cellular towers in a cellular network according to at least one embodiment.

FIG. 2 is a block diagram of an example tower structure characterization system in a cellular network according to at least one embodiment.

FIG. 3 illustrates an example of generating a statistical representation of the tower structure in a cellular network according to at least one embodiment.

FIG. 4 illustrates example sets of statistical representations of the tower structure in a cellular network according to at least one embodiment.

FIGS. 5 and 6 are flow diagrams of example methods of implementing statistical representation of the tower structure in a cellular network according to at least one embodiment.

### DETAILED DESCRIPTION

Technologies for implementing statistical representation of cellular towers in a telecommunications network, such as a cellular network (e.g., 5G wireless network, 6G wireless network) are described. The following description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or presented in simple block diagram format to avoid obscuring the present disclosure unnecessarily. Thus, the specific details set forth are merely exemplary. Particular implementations may vary from these exemplary details and still be contemplated to be within the scope of the present disclosure.

Some structures and/or equipment used in a cellular network are not sufficiently represented and analyzed, which may result in additional complexity and cost for implementing the cellular network.

Aspects and embodiments of the present disclosure address the above and other deficiencies by providing a system that implements a statistical representation of cellular towers in a cellular network. The cellular towers can generally refer to any type of structure of a base station. The base station (e.g., “gNodeB” or “gNB”) refers to a network element responsible for the transmission and reception of radio signals in one or more cells (or coverage areas) to or from user equipment (UE) and may include centralized units (CUs), distributed units (DUs), and radio units (RUs). The cellular towers can specifically refer to a tower structure that may or may not have one or more equipment installed. The tower structure may be a dedicated cellular tower, a building, a water tower, or any other human-made or natural structure to which one or more antennas can reasonably be mounted to provide cellular coverage to a geographic area. The tower structure may include different types of structures, such as monopole structures, lattice structures, guyed structures, stealth structures, etc.

Specifically, a component of the cellular network (e.g., a tower structure characterization system) may receive images of the tower structure in the cellular network. The images of the tower structure refer to images of one or more portions (or entire portions) of the tower structure for measurement/characterization. The images of the tower structure may be captured by and received from various imaging devices, such as optical (e.g., visible spectrum) cameras mounted at telescoping pole or mast or other elevated support systems, or mounted on an aircraft or other aerial systems (e.g., drones), thermal (e.g., infrared) cameras or other types of cameras, which can be used in place of or in addition to the optical cameras, etc.

The component of the cellular network may extract data points in images and generate a statistical representation of the tower structure using the data points. These data points reflect a three-dimensional visual representation of the tower structure (or a portion of the tower structure). For example, a set of images may be required to cover a same portion of the tower structure to extract common points from each of the images. Each point may have a three-dimensional coordinate (X, Y, Z). The extracted data points can be referred to as a “point cloud.” A point cloud is a collection of data points in a coordinate system. The point cloud is typically used to represent a three-dimensional shape or object. Each point in the cloud represents a specific X, Y, and Z coordinate in three-dimensional space. These data points collectively capture an external surface of an object or a scene as a whole. Point clouds can be generated using various techniques, including photogrammetry.

The component of the cellular network may generate a statistical representation of the tower structure based on the extracted points. Unlike a point cloud that represents external surfaces of a tower structure or a portion of the tower structure, a statistical representation represents the tower structure or the portion of the tower structure in terms of statistical metrics. For example, the statistical representation may specify a unit size in a first dimension, such as height (along a Z-axis) relative to the earth. The statistical representation may specify a count of the data points for the given unit size. The count of data points may indicate a density of data points for the given unit size to uniquely characterize the particular portion of the tower structure. In one example, the tower structure can be sliced horizontally, and the statistical representation of the tower structure can specify a count of data points at each horizontal slice of the tower structure. In some implementations, the statistical representation of the tower structure may be in a format of a histogram of a count of the points with respect to a height value in the tower structure. For example, as each point can be represented by a coordinate (X, Y, Z), a count of the points may be a “height-point” count that counts all points having the same Z value. As such, for each height value in the tower structure, a respective count of the points with respect to the height can be determined, and taken together can form the histogram. It can be noted that the data size of the data points may be greater (or significantly greater such as in multiple times) than the data size of the statistical representation (e.g., histogram of height-point count), which can reduce the computing resources used in analyzing and/or charactering the tower structure.

The component of the cellular network may use the statistical representation of the tower structure for various analysis and characterization. In some implementations, the component of the cellular network may identify one or more patterns associated with the tower structure. For example, the component of the cellular network may identify one or more patterns by comparing the statistical representation with a set of predefined statistical representations (e.g., generated historically and/or statistically), and each of the set of predefined statistical representations may correspond to a respective pattern that is specific to an equipment or a set of equipment (“equipment set”) associated with a specific entity. As such, the identified pattern(s) can be used to indicate the entity-specific equipment or equipment set. In some implementations, the component of the cellular network may generate or maintain a database that includes the identified pattern(s) associated with the corresponding statistical representation, and these data can be used as predefined statistical representations and the corresponding pattern for future use. In some implementations, the component of the cellular network may identify one or more patterns by using one or more machine learning models and/or related techniques.

In some implementations, the component of the cellular network may utilize the statistical representations for analysis and characterization in other ways. For example, the statistical representations and/or the identified patterns may be used to perform a verification on one or more parameters (e.g., a height of an equipment) of one or more equipment installed on the tower structure. In another example, the statistical representations and/or the identified patterns may be used to facilitate the design of the tower structure including the installation of one or more equipment, such as the measurement of unused portion of the tower structure, an identification of being unable to install more equipment in a height range of the tower structure, etc.

Aspects and embodiments of the present disclosure can use reduced resources to generate statistical representations of structures used in the cellular network. The generated statistical representations is in a smaller data size compared to traditionally used representation. The statistical representations can provide simple and various use cases for analysis and characterization in the cellular network. Aspects and embodiments of the present disclosure can improve system performance and cost-efficiency by providing such statistical representations.

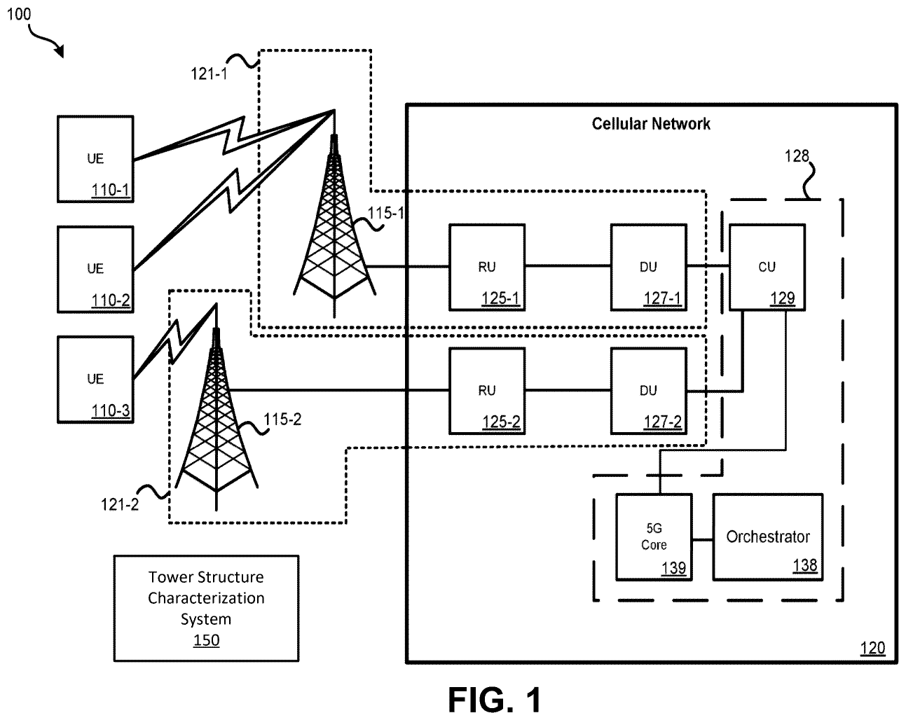

FIG. 1 illustrates an embodiment of a cellular network system 100 (“system 100”). System 100 can include a 5G New Radio (NR) cellular network; other types of cellular networks, such as 6G, 7G, etc. may also be possible. System 100 can include: UEs 110 (UE 110-1, UE 110-2, UE 110-3); base station 121; cellular network 120; radio units 125 (“RUs 125”); distributed units 127 (“DUs 127”); centralized unit 129 (“CU 129”); 5G core 139, and orchestrator 138. FIG. 1 represents a component-level view. In an open radio access network (O-RAN), because components can be implemented as specialized software executed on general-purpose hardware, except for components that need to receive and transmit radio frequency (RF), the functionality of the various components can be shifted among different servers. For at least some components, the hardware may be maintained by a separate cloud-service provider, to accommodate where the functionality of such components is needed.

UE 110 can represent various types of end-user devices, such as cellular phones, smartphones, cellular modems, cellular-enabled computerized devices, sensor devices, gaming devices, access points (APs), any computerized device capable of communicating via a cellular network, etc. Generally, UE can represent any type of device that has an incorporated 5G interface, such as a 5G modem. Examples can include sensor devices, Internet of Things (IoT) devices, manufacturing robots; unmanned aerial (or land-based) vehicles, network-connected vehicles, etc. Depending on the location of individual UEs, UE 110 may use RF to communicate with various base stations of cellular network 120. As illustrated, two base stations 121 are illustrated: base station 121-1 can include: structure 115-1, RU 125-1, and DU 127-1. Similarly, base station 121-2 can include: structure 115-2, RU 125-2, and DU 127-2. Structure 115-1, 115-2 may be any structure to which one or more antennas (not illustrated) of the base station are mounted. Structure 115-1, 115-2 may be a dedicated cellular tower, a building, a water tower, or any other human-made or natural structure to which one or more antennas can reasonably be mounted to provide cellular coverage to a geographic area. Structure 115-1, 115-2 can be referred to tower structure, which may or may not have one or more equipment installed, and may include different types of structures, such as monopole structures, lattice structures, guyed structures, stealth structures, etc.

Real-world implementations of system 100 can include many (e.g., thousands) of base stations (BSs) and many CUs and 5G core 139. Structures 115 can include one or more antennas that allow RUs 125 to communicate wirelessly with UEs 110. RUs 125 can represent an edge of cellular network 120 where data is transitioned to wireless communication. The radio access technology (RAT) used by RU 125 may be 5G New Radio (NR), or some other RAT. The remainder of cellular network 120 may be based on an exclusive 5G architecture, a hybrid 4G/5G architecture, a 4G architecture, or some other cellular network architecture. Base station 121 equipment may include an RU (e.g., RU 125-1) and a DU (e.g., DU 127-1).

One or more RUs, such as RU 125-1, may communicate with DU 127-1. As an example, at a possible cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of the spectrum, such as, for example, band 71. One or more DUs, such as DU 127-1, may communicate with CU 129. Collectively, an RU, DU, and CU create a gNodeB, which serves as the radio access network (RAN) of cellular network 120. CU 129 can communicate with 5G core 139. The specific architecture of cellular network 120 can vary by embodiment. Edge cloud server systems outside of cellular network 120 may communicate, either directly, via the Internet, or via some other network, with components of cellular network 120. For example, DU 127-1 may be able to communicate with an edge cloud server system without routing data through CU 129 or 5G core 139. Other DUs may or may not have this capability.

While FIG. 1 illustrates various components of cellular network 120, other embodiments of cellular network 120 can vary the arrangement, communication paths, and specific components of cellular network 120. While RU 125 may include specialized radio access componentry to enable wireless communication with UE 110, other components of cellular network 120 may be implemented using either specialized hardware, specialized firmware, and/or specialized software executed on a general-purpose server system. In an O-RAN arrangement, specialized software on general-purpose hardware may be used to perform the functions of components such as DU 127, CU 129, and 5G core 139. Functionality of such components can be co-located or located at disparate physical server systems. For example, certain components of 5G core 139 may be co-located with components of CU 129.

In a possible virtualized O-RAN implementation, CU 129, 5G core 139, and/or orchestrator 138 can be implemented virtually as software being executed by general-purpose computing equipment, such as in a data center of a cloud-computing platform, as detailed herein. Therefore, depending on needs, the functionality of a CU, and/or 5G core may be implemented locally to each other and/or specific functions of any given component can be performed by physically separated server systems (e.g., at different server farms). For example, some functions of a CU may be located at a same server facility as where the DU is executed, while other functions are executed at a separate server system. In the illustrated embodiment of system 100, cloud-based cellular network components 128 include CU 129, 5G core 139, and orchestrator 138. Such cloud-based cellular network components 128 may be executed as specialized software executed by underlying general-purpose computer servers. Cloud-based cellular network components 128 may be executed on a third-party cloud-based computing platform or a cloud-based computing platform operated by the same entity that operates the RAN. A cloud-based computing platform may have the ability to devote additional hardware resources to cloud-based cellular network components 128 or implement additional instances of such components when requested.

Kubernetes, or some other container orchestration platform, can be used to create and destroy the logical CU or 5G core units and subunits as needed for the cellular network 120 to function properly. Kubernetes allows for container deployment, scaling, and management. As an example, if cellular traffic increases substantially in a region, an additional logical CU or components of a CU may be deployed in a data center near where the traffic is occurring without any new hardware being deployed. (Rather, processing and storage capabilities of the data center would be devoted to the needed functions.) When the need for the logical CU or subcomponents of the CU no longer exists, Kubernetes can allow for removal of the logical CU. Kubernetes can also be used to control the flow of data (e.g., messages) and inject a flow of data to various components. This arrangement can allow for the modification of nominal behavior of various layers.

The deployment, scaling, and management of such virtualized components can be managed by orchestrator 138. Orchestrator 138 can represent various software processes executed by underlying computer hardware. Orchestrator 138 can monitor cellular network 120 and determine the amount and location at which cellular network functions should be deployed to meet or attempt to meet service level agreements (SLAs) across slices of the cellular network.

Orchestrator 138 can allow for the instantiation of new cloud-based components of cellular network 120. As an example, to instantiate a new core function, orchestrator 138 can perform a pipeline of calling the core function code from a software repository incorporated as part of, or separate from, cellular network 120; pulling corresponding configuration files (e.g., helm charts); creating Kubernetes nodes/pods; loading the related core function containers; configuring the core function; and activating other support functions (e.g., Prometheus, instances/connections to test tools).

A network slice functions as a virtual network operating on cellular network 120. Cellular network 120 is shared with some number of other network slices, such as hundreds or thousands of network slices. Communication bandwidth and computing resources of the underlying physical network can be reserved for individual network slices, thus allowing the individual network slices to reliably meet defined SLA parameters. By controlling the location and amount of computing and communication resources allocated to a network slice, the quality of service (QoS) and quality of experience (QoE) for UE can be varied on different slices. A network slice can be configured to provide sufficient resources for a particular application to be properly executed and delivered (e.g., gaming services, video services, voice services, location services, sensor reporting services, data services, etc.). However, resources are not infinite, so allocation of an excess of resources to a particular UE group and/or application may be desired to be avoided. Further, a cost may be attached to cellular slices: the greater the amount of resources dedicated, the greater the cost to the user; thus, optimization between performance and cost is desirable.

Particular network slices may only be reserved in particular geographic regions. For instance, a first set of network slices may be present at RU 125-1 and DU 127-1, a second set of network slices, which may only partially overlap or may be wholly different from the first set, may be reserved at RU 125-2 and DU 127-2.

Further, particular cellular network slices may include some number of defined layers. Each layer within a network slice may be used to define QoS parameters and other network configurations for particular types of data. For instance, high-priority data sent by a UE may be mapped to a layer having relatively higher QoS parameters and network configurations than lower-priority data sent by the UE that is mapped to a second layer having relatively less stringent QoS parameters and different network configurations.

Components such as DUs 127, CU 129, orchestrator 138, and 5G core 139 may include various software components that are required to communicate with each other, handle large volumes of data traffic, and are able to properly respond to changes in the network. In order to ensure not only the functionality and interoperability of such components, but also the ability to respond to changing network conditions and the ability to meet or perform above vendor specifications, significant testing must be performed.

5G core 139, which can be physically distributed across data centers or located at a central national data center (NDC), can perform various core functions of the cellular network. 5G core 139 can include: network resource management components; policy management components; subscriber management components; and packet control components. Individual components may communicate on a bus, thus allowing various components of 5G core 139 to communicate with each other directly. 5G core 139 is simplified to show some key components. Implementations can involve additional other components.

Network resource management components can include network repository function (NRF) and network slice selection function (NSSF). NRF can allow 5G network functions (NFs) to register and discover each other via a standards-based application programming interface (API). NSSF can be used by access and mobility management function (AMF) to assist with the selection of a network slice that will serve a particular UE.

Policy management components can include charging function (CHF) and policy control function (PCF). CHF allows charging services to be offered to authorized network functions. Converged online and offline charging can be supported. PCF allows for policy control functions and the related 5G signaling interfaces to be supported.

Subscriber management components can include unified data management (UDM) and authentication server function (AUSF). UDM can allow for generation of authentication vectors, user identification handling, NF registration management, and retrieval of UE individual subscription data for slice selection. AUSF performs authentication with UE.

Packet control components can include access and mobility management function (AMF) and session management function (SMF). AMF can receive connection- and session-related information from UE and is responsible for handling connection and mobility management tasks. SMF is responsible for interacting with the decoupled data plane, creating updating and removing protocol data unit (PDU) sessions, and managing session context with the user plane function (UPF) (e.g., manage UE context and network handovers between base stations).

User plane function (UPF) can be responsible for packet routing and forwarding, packet inspection, QoS handling, and external PDU sessions for interconnecting with a data network (DN) (e.g., the Internet) or various access networks. Access networks can include the RAN of cellular network 120.

The SMF may configure or control the UPF via the N4 interface. For example, the SMF may control packet forwarding rules used by the UPF and adjust QoS parameters for QoS enforcement of data flows (e.g., limiting available data rates). In some cases, multiple SMF/UPF pairs may be used to simultaneously manage user plane traffic for a particular user device, such as UE. For example, a set of SMFs may be associated with UE, where each SMF of the set of SMFs corresponds with a network slice. The SMF may control the UPF on a per end user data session basis, in which the SMF may create, update, and remove session information in the UPF.

Decoupling control signaling in the control plane from user plane traffic in the user plane may allow the UPF to be positioned in close proximity to the edge of a network compared with the AMF. As a closer geographic or topographic proximity may reduce the electrical distance, the electrical distance from the UPF to the UE may be less than the electrical distance of the AMF to the UE.

5G core 139 may reside on a cloud computing platform. While from a client's or user's point of view, the “cloud” can be envisioned as an ephemeral computing workspace that occupies no physical space, in reality, a cloud computing platform is an interconnected group of data centers throughout which computing and storage resources are spread. Therefore, data centers may be scattered geographically and can provide redundancy.

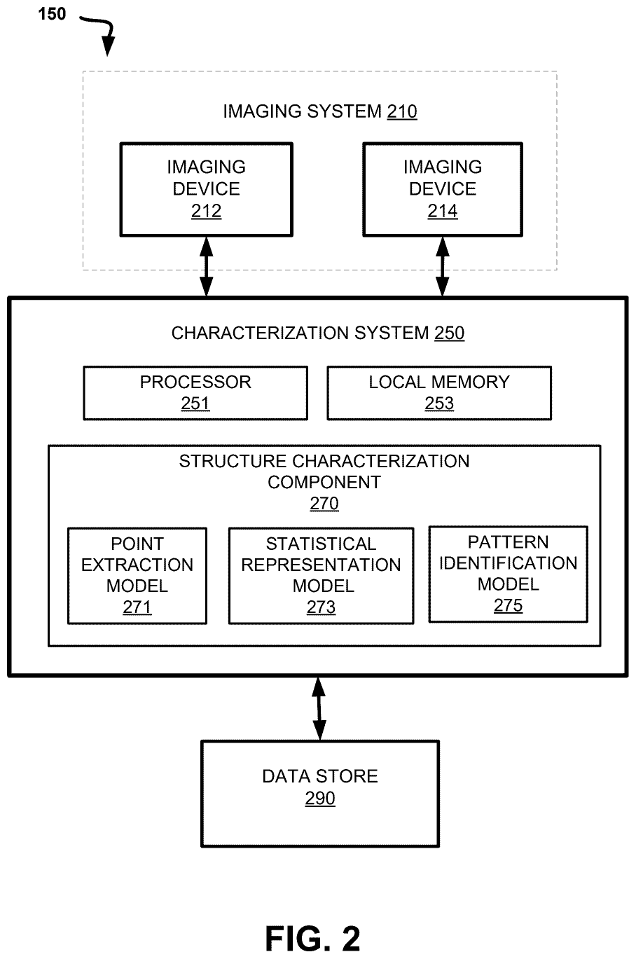

In some embodiments, the system 100 includes a tower structure characterization system 150 that implements statistical representation of cellular towers in a cellular network. In some embodiments, the tower structure characterization system 150 is part of the base station(s). In some embodiments, the tower structure characterization system 150 is part of the 5G core 139. Further details regarding the operations of the tower structure characterization system 150 are described below with reference to FIGS. 2-6.

FIG. 2 illustrates an example tower structure characterization system 150 that includes a characterization system 250 in accordance with some embodiments of the present disclosure. It can be noted that aspects of the present disclosure can be used for any type of base station structure in cellular networks. In the examples described herein, the base station structure that is examined by the system 150 includes a tower structure, which may or may not have one or more equipment installed.

The tower structure characterization system 150 may include an imaging system 210 to obtain images of the tower structure. The images of the tower structure may include images of one or more measurement/characterization portions (or all measurement/characterization portions) of the tower structure. The imaging system 110 may include one or more imaging devices (e.g., imaging devices 212, 214). The imaging system 210 may obtain images of the measurement/characterization area and transmit to the characterization system 250. The characterization system 250 can process the received data and generate and forward the characterization data to other platform, which may perform other analyzing actions. The tower structure characterization system 150 may include a data store 290. The data store 290 can also store any data involved in the operations of tower structure characterization system 150. Although not shown in FIG. 2, the tower structure characterization system 150 may include additional storage, circuitry or components such as user interfaces, which are necessary for implementing the present disclosure.

The imaging device 212, 214 may be configured to capture images of the measurement/characterization portions of the tower structure (e.g., at relatively low-speed and/or high-resolution, or at relatively high-speed and/or low-resolution). The imaging device 212, 214 may include optical (e.g., visible spectrum) cameras mounted at telescoping pole or mast or other elevated support systems, or mounted on an aircraft or other aerial systems (e.g., drones). In some implementations, the imaging device 212, 214 may include thermal (e.g., infrared) cameras or other types of cameras, which can be used in place of or in addition to the optical cameras. The images captured by the imaging devices 212, 214 can be used for characterization as described below.

The imaging system 210 can be coupled to the characterization system 250 via a communication interface (e.g., a wired or wireless network interface). The characterization system 250 can be a computing system running one or more image processing applications described herein, including a processing device and a software stack executable by the processing device. For example, the characterization system 250 can include a processor 251 (e.g., processing device) configured to execute instructions stored in local memory 253. In the illustrated example, the local memory 253 of the characterization system 250 includes an embedded memory configured to store instructions for performing various processes, operations, logic flows, and routines that control operation of the characterization system 250, including handling communications between the imaging system 210 and the characterization system 250.

The characterization system 250 includes a structure characterization component 270 that is capable of generating and utilizing statistical representation of the tower structure using images. In some embodiments, the characterization system 250 includes at least a portion of the structure characterization component 270. In some embodiments, the structure characterization component 270 is part of the imaging system 210, an application, or an operating system. In some embodiments, the structure characterization component 270 can have configuration data, libraries, and other information stored in the data store.

In some embodiments, the structure characterization component 270 can receive, from the imaging system 210, instructions to perform a structure characterization. For example, the structure characterization component 270 may receive, from the imaging device 212, 214, a request for an additional structure characterization, for example, of a specific area of the tower structure.

The structure characterization component 270 can receive an image from the imaging system 210. In some implementations, the image is received from the imaging device 212, 214. In some implementations, the structure characterization component 270 may preprocess to reduce the size of the image by cropping the image, binarizing the image, filtering the image, segmenting the image, applying certain geometric transformations to the image, or identifying a plurality of regions in the image (instead of using the whole image) for the structure characterization.

Performing a structure characterization by the structure characterization component 270 may involve extracting points in images using a point extraction model 271, generating a statistical representation of the tower structure using a statistical representation model 273, and identifying a pattern associated with the tower structure using a pattern identification model 275.

The point extraction model 271 may extract data points in images of the tower structure. These data points reflect a three-dimensional visual representation of the tower structure (or a portion of the tower structure). The images are received from an imaging device and may cover a portion of the tower structure. For example, a set of images may be required to cover a same portion of the tower structure to extract common points from each of the images. Each point has a three dimensional coordinate (X, Y, Z).

The extracted data points can be referred to as a “point cloud.” A point cloud is a collection of data points in a coordinate system. The point cloud is one method that is typically used to represent a three-dimensional shape or object. Each point in the cloud represents a specific X, Y, and Z coordinate in three-dimensional space. These data points collectively capture an external surface of an object or a scene as a whole. Point clouds can be generated using various techniques, including photogrammetry.

Photogrammetry is a technique of extracting three-dimensional information about physical objects from photographic images and electromagnetic radiant imagery. For example, the point extraction model 271 may receive a set of overlapping images of the target object (e.g., the tower structure or a portion of the tower structure), where the overlapping images are captured by cameras from different positions and different angles. The information of the camera positions and camera orientations are also obtained. The overlapping images need to cover all aspects and angles of the target object to ensure an enough dataset for information extraction. The point extraction model 271 may analyze the overlapping images to find common points or features of the overlapping images. These common points or features are matched across the set of overlapping images. The point extraction model 271 may construct lines from camera locations to the common points and calculate the three-dimensional coordinates of the points by intersecting these lines. The accuracy of calculation depends on the number of images, image resolution, and the precision in feature matching. The point extraction model 271 may compile the calculated three-dimensional coordinates of the points into a point cloud. The point extraction model 271 may perform additional processing such as removing outliers or filling gaps between points. In some cases, the point cloud obtained from the photogrammetry can be complemented with other data, such as range data supplied by light detection and ranging (LiDAR). LiDAR determines ranges by targeting an object or a surface with a laser and measuring the time for the reflected light to return to the receiver. The point extraction model 271 may thus generate the point cloud complemented with range data.

In some implementations, each point may use the ground as a XY coordinate plane, and use the central axis of the tower structure as a Z axis. In such coordinate case, the height level in the tower structure can be represented by the value of Z axis. Although a coordinate system using ground as XY coordinate plane and central axis of the tower structure as a Z axis is illustrated here as an example, other coordinate systems are also applicable, and to simplify the description, the following illustration uses the same coordinate system described here.

In some implementations, the point extraction model 271 may preprocess the images, including, for example, cropping the image, binarizing the image, filtering the image, segmenting the image, applying certain geometric transformations to the image, etc. In some implementations, the point extraction model 271 may preprocess the image to reduce the size of the image by identifying multiple candidate regions in the image (instead of using the whole image). In some implementations, the point extraction model 271 may define the multiple candidate regions according to information received with the image.

In some examples, the point extraction model 271 may extract points in the image according to a predefined sampling rate. In some examples, the point extraction model 271 may extract points in the image according to a predefined distance between points. In some examples, the number of points to be extracted may be predefined, and the point extraction model 271 may extract points in the image according to the predefined number. In some examples, the number of points to be extracted may be determined dynamically, for example, based on a total data size of the images. In some examples, the point extraction model 271 may extract points in the image with color (e.g., RGB) information associated with each point.

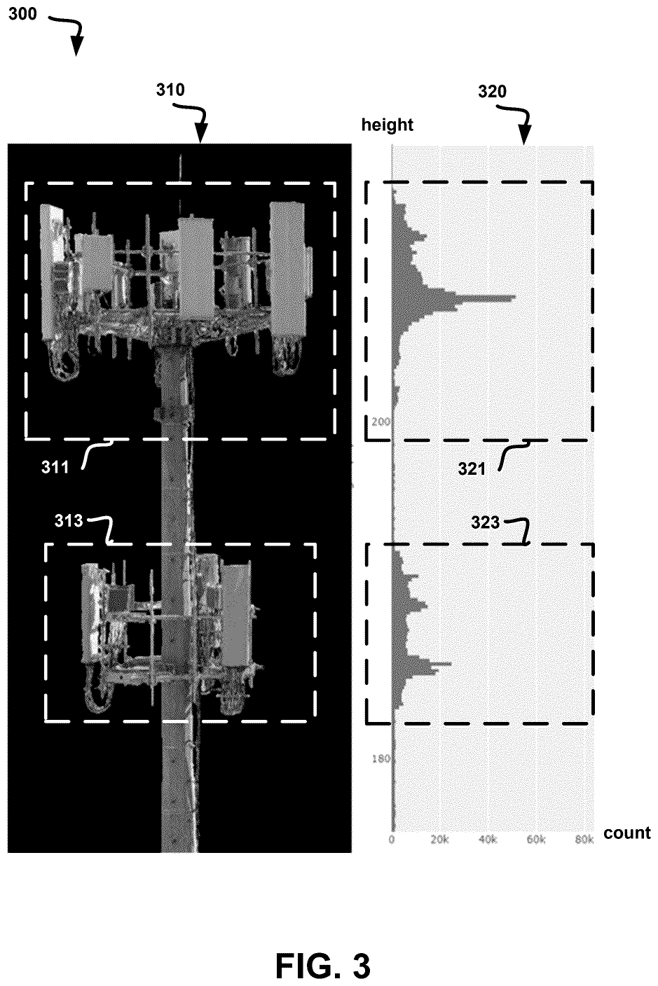

The statistical representation model 273 may generate a statistical representation of the tower structure based on the points extracted by the point extraction model 271. Unlike a point cloud that represents external surfaces of a tower structure or a portion of the tower structure, a statistical representation represents the tower structure or the portion of the tower structure in terms of statistical metrics. For example, the statistical representation may specify a unit size in a first dimension, such as height (along a Z-axis) relative to the earth. The statistical representation may specify a count of the data points for the given unit size. The count of data points may indicate a density of data points for the given unit size to uniquely characterize the particular portion of the tower structure. In one example, the tower structure can be sliced horizontally, and the statistical representation of the tower structure can specify a count of data points at each horizontal slice of the tower structure In some implementations, the statistical representation of the tower structure may be in a format of a histogram of a count of the points with respect to a height value in the tower structure. For example, as each point can be represented by a coordinate (X, Y, Z), a count of the points may be a height-point count that counts all points having the same Z value. An example of generating a statistical representation of the tower structure based on the points is illustrated in FIG. 3.

Referring to FIG. 3, the graph 310 illustrates points extracted by the point extraction model 271, and the graph 320 illustrates an example of the statistical representation (i.e., a histogram of point counts with respect to heights) of the tower structure that are generated using the points in graph 310. The graph 310 may include a first set of points 331 and a second set of points 313, where the first set of points 331 may be a group of points in a height range of the tower structure and a second set of points 313 may be a group of points in another height range of the tower structure. The histogram in graph 320 may include a first histogram part 321 and a second histogram part 323, where the first histogram part 321 is generated from the first set of points 311 and the second histogram part 323 is generated from the second set of points 313. It can be noted that the data size of the points is greater (or significantly greater such as in multiple times) than the data size of the statistical representation, which reduces the computing resources used in charactering the tower structure.

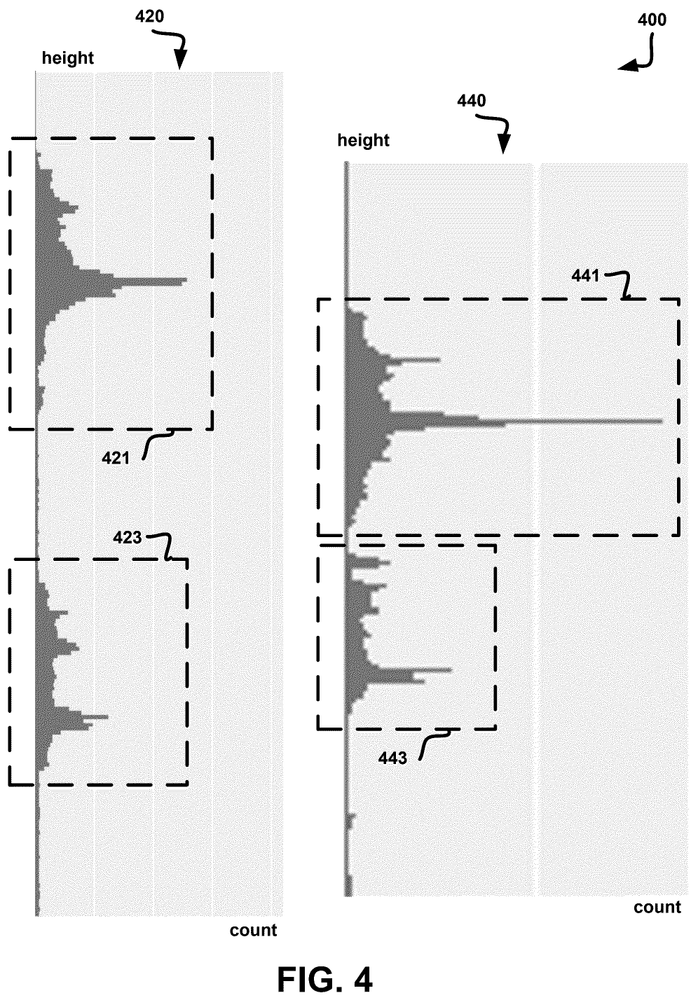

The pattern identification model 275 may identify, using the statistical representation, one or more patterns associated with the tower structure. In some implementations, the pattern identification model 275 may identify one or more patterns by comparing the statistical representation with a set of predefined statistical representations, and each of the set of predefined statistical representations may correspond to a respective pattern that is specific to an equipment or a set of equipment (“equipment set”) associated with an entity. The set of predefined statistical representations can therefore include various entity-specific equipment or equipment set. As such, the identified pattern can be used to indicate the entity-specific equipment or equipment set. In some implementations, the set of predefined statistical representations and the correspond pattern can be stored in the data store 290. Examples of sets of statistical representations of the tower structure are illustrated in FIG. 4.

Referring to FIG. 4, the graph 420 may be a histogram including a histogram part 421 and a histogram part 423, and the graph 440 may be a histogram including a histogram part 441 and a histogram part 443. In some implementations, the histogram part 421 may be a first set of statistical representation corresponding to a first pattern, the histogram part 423 may be a second set of statistical representation corresponding to a second pattern, the histogram part 441 may be a third set of statistical representation corresponding to a third pattern, and the histogram part 443 may be a fourth set of statistical representation corresponding to a fourth pattern. Each pattern may be specific to a respective equipment or equipment set associated with a respective entity. In some implementations, one or more of histogram parts 421, 423, 441, 443 may be a same pattern. In some implementations, a pattern may reflect a specific shape in the histogram. In some implementations, a pattern may reflect shapes having the same aspect ratio. In some implementations, a set of similar shapes in the histogram may be defined as one pattern. In some implementations, the patterns may reflect the shape of a combination of corners, edges, junctions, lines, etc. in the histogram. In some implementations, a pattern may reflect a shape associated with a height, for example, same shapes associated with different heights may be defined as different patterns.

Using an illustrative example, a first pattern may be specific to a first entity (e.g., a corresponding entity identifier may be stored as metadata of the first pattern) and correspond to a first equipment set including six radio units, three antennas, an over-voltage protection box, and the related mount devices; a second pattern may be specific to a second entity (e.g., a corresponding entity identifier may be stored as metadata of the second pattern) and correspond to a second equipment set including server radio units, several antennas, an over-voltage protection box, and the related mount devices. In some implementations, the first pattern and the second pattern can be differentiated because an element (e.g., the radio unit, antenna, over-voltage protection box, related mount device) of the first equipment set and a similar element (e.g., the radio unit, antenna, over-voltage protection box, related mount device, respectively) of the second equipment set have different external surfaces. In some implementations, the first pattern and the second pattern can be differentiated because the gaps between elements (e.g., the radio units, antennas, over-voltage protection box, related mount devices) of the first equipment set and the similar gaps between elements (e.g., the radio units, antennas, over-voltage protection box, related mount devices) of the second equipment set are different. In some implementations, the first pattern and the second pattern can be differentiated because the first equipment set and the second equipment set have different number of the elements (e.g., the radio unit, antenna, over-voltage protection box, related mount device). For example, the first pattern may be shown as histogram 421, the second pattern may be shown as histogram 423, and the first pattern and the second pattern can be differentiated by the pattern identification model 275, and used by the pattern identification model 275 to identify one or more patterns associated with the tower structure.

The pattern identification model 275 may, by comparing the statistical representation 320 (e.g., including the histogram part 321 and the histogram part 323) with a set of predefined statistical representations (e.g., the histogram parts 421, 423, 441, 443), identify one or more patterns (e.g., the first pattern corresponding to the histogram part 321 and the second pattern corresponding to the histogram part 323). As such, the identified first and second pattern can be used to indicate the entity-specific equipment or equipment set.

In some embodiments, the pattern identification model 275 can be implemented by one or more machine learning models. The pattern identification model 275 can be trained on a number of datasets that may include statistical representations and the corresponding patterns. In some implementations, the machine learning model(s) can include multiple neural networks and can be trained prior to being installed in the characterization system 250. The machine learning model(s) can also be a learning model based on the image measured or a reinforcement learning model.

To train the machine-learning model to identify pattern, training datasets are generated, for example, by labeling of statistical representations (e.g., histogram) with patterns specific to entity and equipment or equipment set. During the training phase, the pattern identification model can process the set of statistical representations (e.g., histogram) to output a predicted pattern and compare the predicted pattern with the labeled pattern specified by the training metadata. Based on the comparison result, one or more parameters of the pattern identification model can be adjusted.

A training engine can further establish input-output associations between training inputs and the corresponding target output. In establishing the input-output associations, the training engine can use algorithms of grouping and clustering, such as the Density-based spatial clustering of applications with noise (DBSCAN) algorithm, or similar algorithms. As such, the pattern identification model can develop associations between a particular set of statistical representations (e.g., histogram) and a labeled pattern. Then, during identifying (testing) phase, the pattern identification model can receive, as an input, statistical representations (e.g., histogram), and identify, as an output, patterns that represent an entity-specific equipment or equipment set.

In some implementations, the pattern identification model 275 may utilize the statistical representations for analysis and characterization in other ways. In one implementation, the generated statistical representation and/or the identified pattern(s) may be used to perform a verification on one or more parameters of one or more equipment installed on the tower structure. For example, the pattern identification model 275 may calculate the height range of the pattern that is specific to one or more equipment installed on the tower structure. As the height range of the histogram part 321 and the height range of the histogram part 323 illustrated in FIG. 3, the pattern identification model 275 may perform a verification on the equipment height using the calculated height range of the pattern that is specific to the equipment installed on the tower structure.

In some implementations, the statistical representations and/or the identified pattern(s) may be used to facilitate the design of the tower structure including the installation of one or more equipment. In one implementation, the statistical representations may be used to perform, using the generated statistical representation, a measurement on one or more parameters of the tower structure. For example, the pattern identification model 275 may calculate the height range in which a point count of the height is below a threshold value. As the height range between the histogram part 321 and the histogram part 323 illustrated in FIG. 3, the point count of each height in the height range is below a threshold value, and the pattern identification model 275 may calculate the height range as a measurement of unused portion of the tower structure.

In another implementation, the statistical representations may be used to perform, using the generated statistical representation, an identification on one or more parameters of the tower structure. For example, the pattern identification model 275 may calculate, for a specific height range, a total count of points exceeding a threshold value. As the height range of the histogram part 321 illustrated in FIG. 3, the total count of points of each height in the height range is over a threshold value, and the pattern identification model 275 may identify the height range as being unable to install more equipment in that height range.

In some implementations, the structure characterization component 270 can gather the statistical representation generated by the statistical representation model 273 and/or the corresponding patterns identified by the pattern identification model 275 to generate a database, for example, stored in the data store 290. The database may include multiple statistical representations and/or the corresponding patterns for future use by the structure characterization component 270 or other components for analysis or characterization of the statistical representations.

In some implementations, a system (e.g., system 100 in FIG. 1) may include a computing system to facilitate a cellular network (e.g., the cellular network 120 in FIG. 1), the computing system may include one or more processing devices and memory communicatively coupled with and readable by the one or more processing devices and having stored therein processor-readable instructions which, when executed by the one or more processing devices, cause the one or more processing devices to perform operations described herein.

The computing system may be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The processing device may represent one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device may also be one or more special-purpose processing devices such as an application specific integrated circuit (ASIC), a field programmable gate array (FPGA), a digital signal processor (DSP), network processor, or the like. Processing device may be configured to execute processor-readable instructions for performing the operations and steps discussed herein.

The memory may represent any combination of the different types of non-volatile memory devices (e.g., not-and (NAND) type flash memory and write-in-place memory, such as a three-dimensional cross-point (“3D cross-point”) memory device) and/or volatile memory devices (e.g., random access memory (RAM), such as dynamic random access memory (DRAM) and synchronous dynamic random access memory (SDRAM)). Examples of memory include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory further include a dual in-line memory module (DIMM), a small outline DIMM (SO-DIMM), and various types of non-volatile dual in-line memory modules (NVDIMMs).

In some implementations, a system (e.g., system 100 in FIG. 1) may include one or more non-transitory, computer-readable storage media having computer-readable instructions thereon which, when executed by one or more processing devices, cause the one or more processing devices to perform operations described herein. The term “computer-readable storage medium” should be taken to include a single medium or multiple media that store the one or more sets of instructions. The term “computer-readable storage medium” shall also be taken to include any medium that is capable of storing or encoding a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media. Processor-readable instructions or computer-readable instructions may include instructions to implement functionality corresponding to a tower structure characterization system 150 (e.g., the tower structure characterization system 150 of FIGS. 1 and 2).

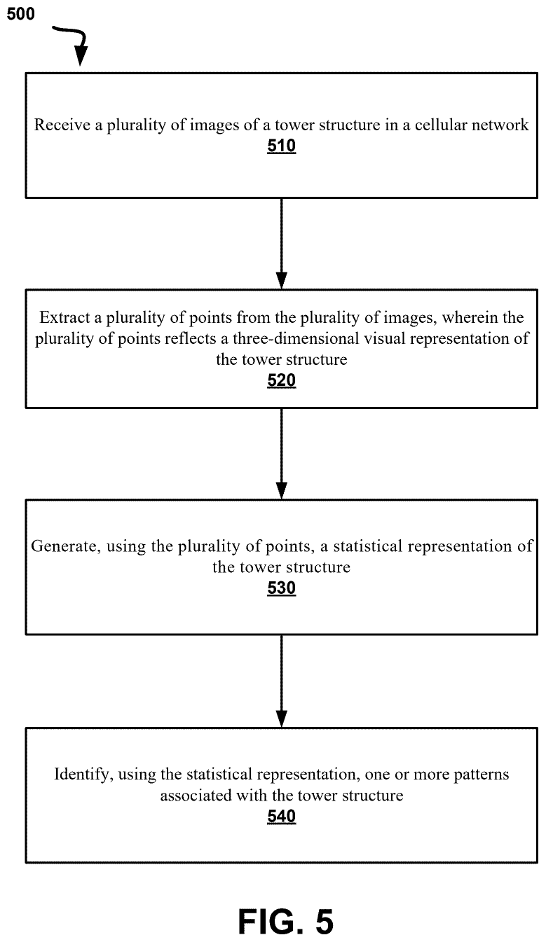

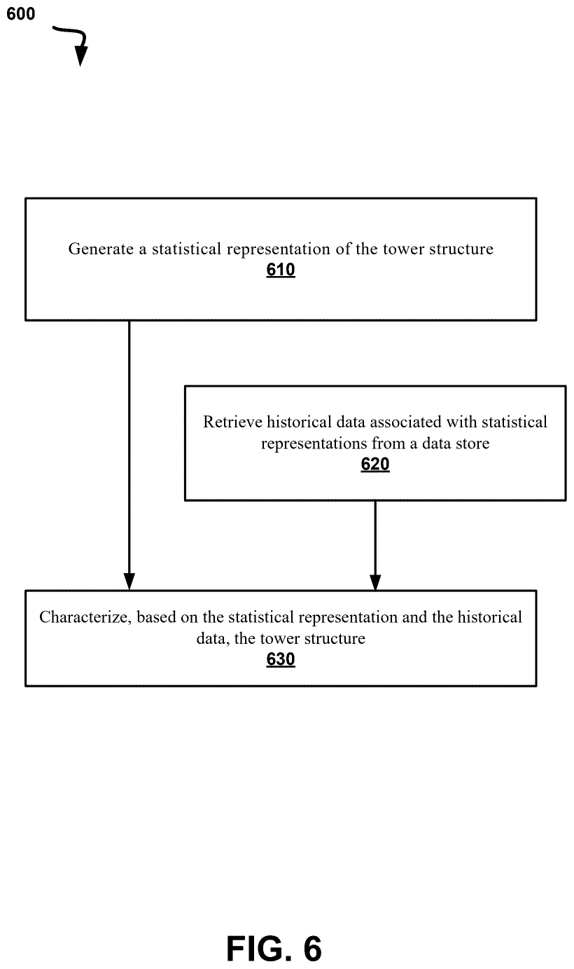

FIGS. 5 and 6 are flow diagrams of methods 500 and 600 of implementing statistical representation of cellular towers in a cellular network according to at least one embodiment. The methods 500 and 600 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the methods 500 and 600 are performed by the system 100 of FIG. 1. In one embodiment, the methods 500 and 600 are performed by the tower structure characterization system 150 of FIGS. 1 and 2.

Referring to FIG. 5, at operation 510, the processing logic may receive a plurality of images of a tower structure in a cellular network. In some implementations, each image of the plurality of images of the tower structure corresponds to a portion of the tower structure. In some implementations, the tower structure includes one or more equipment installed on the tower structure.

At operation 520, the processing logic may extract a plurality of data points from the plurality of images, wherein the plurality of data points reflects a three-dimensional visual representation of the tower structure. In some implementations, the processing logic may extract the plurality of data points according to a predefined sampling rate or a predefined distance between points. In some implementations, each point of the plurality of data points is represented by a three dimensional coordinate.

At operation 530, the processing logic may generate, using the plurality of points, a statistical representation of the tower structure. In some implementations, the statistical representation comprises a histogram of a plurality of counts with respect to a plurality of height values in the tower structure, wherein each count counts a respective subset of the plurality of points, and wherein the respective subset of the plurality of data points has a respective height value of the plurality of height values. In some implementations, each pattern of the one or more patterns associated with the tower structure identifies an equipment or a set of equipment associated with an entity.

At operation 540, the processing logic may identify, using the statistical representation, one or more patterns associated with the tower structure. In some implementations, to identify one or more patterns, the processing logic may compare the statistical representation with a plurality of predefined statistical representations, wherein each predefined statistical representation of the set of predefined statistical representations corresponds to a respective pattern that is specific to an equipment or a set of equipment associated with an entity.

In some implementations, the processing logic may perform, using the one or more patterns, a verification on one or more parameters of one or more equipment installed on the tower structure, wherein the one or more equipment is identified by the one or more patterns. In some implementations, the processing logic may perform, using the statistical representation, an identification or a measurement on one or more parameters of the tower structure. In some implementations, the processing logic may generate a database comprising a plurality of statistical representations including the statistical representation.

Referring to FIG. 6, at operation 610, the processing logic may generate a statistical representation of the tower structure. In some implementations, the processing logic may generate the statistical representation same as or similar to the operation 530. In some implementations, the processing logic may generate, directly from a set of images of the tower structure, the statistical representation.

At operation 620, the processing logic may retrieve historical data associated with statistical representations from a data store. In some implementations, the historical data associated with statistical representations may include a set of predefined statistical representations, where each predefined statistical representation of the set of predefined statistical representations corresponds to a respective pattern that is specific to an equipment or a set of equipment associated with an entity.

At operation 630, the processing logic may characterize, based on the statistical representation and the historical data, the tower structure. In some implementations, the processing logic may characterize the tower structure by identifying, using the statistical representation, one or more patterns associated with the tower structure same as or similar to the operation 540. In some implementations, the processing logic may characterize the tower structure by performing, using the one or more patterns, a verification on one or more parameters of one or more equipment installed on the tower structure, wherein the one or more equipment is identified by the one or more patterns. In some implementations, the processing logic may characterize the tower structure by performing, using the statistical representation, an identification or a measurement on one or more parameters of the tower structure.

In the above description, numerous details are set forth. It will be apparent, however, to one of ordinary skill in the art having the benefit of this disclosure, that embodiments may be practiced without these specific details. In some instances, well-known structures and devices are shown in block diagram form rather than in detail in order to avoid obscuring the description.

Some portions of the detailed description are presented in terms of algorithms and symbolic representations of operations on data bits within a computer memory. These algorithmic descriptions and representations are the means used by those skilled in the data processing arts to convey the substance of their work most effectively to others skilled in the art. An algorithm is used herein and is generally conceived to be a self-consistent sequence of steps leading to the desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining,” “sending,” “receiving,” “scheduling,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments also relate to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk including floppy disks, optical disks, Read-Only Memories (ROMs), compact disc ROMs (CD-ROMs), and magnetic-optical disks, Random Access Memories (RAMs), EPROMS, EEPROMs, magnetic or optical cards, or any type of media suitable for storing electronic instructions. One or more non-transitory, computer-readable storage media can have computer-readable instructions stored thereon which, when executed by one or more processing devices, cause the one or more processing devices to perform the operations described herein.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the present embodiments as described herein. It should also be noted that the terms “when” or the phrase “in response to,” as used herein, should be understood to indicate that there may be intervening time, intervening events, or both before the identified operation is performed.

It is to be understood that the above description is intended to be illustrative, and not restrictive. Many other embodiments will be apparent to those of skill in the art upon reading and understanding the above description. The scope of the present embodiments should, therefore, be determined with reference to the appended claims, along with the full scope of equivalents to which such claims are entitled.

What is claimed is:

1. A method comprising:
receiving, by a processing device, a plurality of images of a tower structure in a cellular network;
extracting a plurality of data points from the plurality of images, wherein the plurality of data points reflects a three-dimensional visual representation of the tower structure;
generating, using the plurality of data points, a statistical representation of the tower structure; and
identifying, using the statistical representation, one or more patterns associated with the tower structure.

2. The method of claim 1, wherein the statistical representation comprises a histogram of a plurality of counts with respect to a plurality of height values in the tower structure, wherein each count of plurality of counts counts a respective subset of the plurality of points, and wherein the respective subset of the plurality of data points has a respective height value of the plurality of height values.

3. The method of claim 1, wherein the plurality of data points is extracted according to a predefined sampling rate or a predefined distance between points, and wherein each point of the plurality of data points is represented by a three-dimensional coordinate.

4. The method of claim 1, wherein each pattern of the one or more patterns associated with the tower structure identifies an equipment or a set of equipment associated with an entity.

5. The method of claim 1, wherein identifying the one or more patterns associated with the tower structure further comprises:
comparing the statistical representation with a plurality of predefined statistical representations, wherein each predefined statistical representation of the set of predefined statistical representations corresponds to a respective pattern that is specific to an equipment or a set of equipment associated with an entity.

6. The method of claim 1, further comprising:
performing, using the one or more patterns, a verification on one or more parameters of one or more equipment installed on the tower structure, wherein the one or more equipment is identified by the one or more patterns.

7. The method of claim 1, further comprising:
performing, using the statistical representation, an identification or a measurement on one or more parameters of the tower structure.

8. The method of claim 1, further comprising:
generating a database comprising a plurality of statistical representations including the statistical representation.

9. A computing system to facilitate a cellular network, the computing system comprising:
one or more processing devices; and
a memory communicatively coupled with and readable by the one or more processing devices and having stored therein processor-readable instructions which, when executed by the one or more processing devices, cause the one or more processing devices to perform operations comprising:
receiving a plurality of images of a tower structure in the cellular network;
extracting a plurality of data points from the plurality of images, wherein the plurality of data points reflects a three-dimensional visual representation of the tower structure;
generating, using the plurality of data points, a statistical representation of the tower structure; and
identifying, using the statistical representation, one or more patterns associated with the tower structure.

10. The computing system of claim 9, wherein the statistical representation comprises a histogram of a plurality of counts with respect to a plurality of height values in the tower structure, wherein each count of plurality of counts counts a respective subset of the plurality of points, and wherein the respective subset of the plurality of data points has a respective height value of the plurality of height values.

11. The computing system of claim 9, wherein the plurality of data points is extracted according to a predefined sampling rate or a predefined distance between points, and wherein each point of the plurality of data points is represented by a three-dimensional coordinate.

12. The computing system of claim 9, wherein each pattern of the one or more patterns associated with the tower structure identifies an equipment or a set of equipment associated with an entity.

13. The computing system of claim 9, wherein identifying the one or more patterns associated with the tower structure further comprises:
comparing the statistical representation with a plurality of predefined statistical representations, wherein each predefined statistical representation of the set of predefined statistical representations corresponds to a respective pattern that is specific to an equipment or a set of equipment associated with an entity.

14. The computing system of claim 12, wherein the operations further comprise:
performing, using the one or more patterns, a verification on one or more parameters of one or more equipment installed on the tower structure, wherein the one or more equipment is identified by the one or more patterns.

15. The computing system of claim 12, wherein the operations further comprise:
performing, using the statistical representation, an identification or a measurement on one or more parameters of the tower structure.

16. One or more non-transitory, computer-readable storage media having computer-readable instructions thereon which, when executed by one or more processing devices, cause the one or more processing devices to perform operations comprising:
receiving a plurality of images of a tower structure in a cellular network;
extracting a plurality of data points from the plurality of images, wherein the plurality of data points reflects a three-dimensional visual representation of the tower structure;
generating, using the plurality of data points, a statistical representation of the tower structure; and
identifying, using the statistical representation, one or more patterns associated with the tower structure.

17. The one or more non-transitory, computer-readable storage media of claim 16, wherein the statistical representation comprises a histogram of a plurality of counts with respect to a plurality of height values in the tower structure, wherein each count of plurality of counts counts a respective subset of the plurality of points, and wherein the respective subset of the plurality of data points has a respective height value of the plurality of height values.

18. The one or more non-transitory, computer-readable storage media of claim 16, wherein the plurality of data points is extracted according to a predefined sampling rate or a predefined distance between points, and wherein each point of the plurality of data points is represented by a three-dimensional coordinate.

19. The one or more non-transitory, computer-readable storage media of claim 16, wherein each pattern of the one or more patterns associated with the tower structure identifies an equipment or a set of equipment associated with an entity.

20. The one or more non-transitory, computer-readable storage media of claim 16, wherein identifying the one or more patterns associated with the tower structure further comprises:
comparing the statistical representation with a plurality of predefined statistical representations, wherein each predefined statistical representation of the set of predefined statistical representations corresponds to a respective pattern that is specific to an equipment or a set of equipment associated with an entity.
